(19) United States
(12) Patent Application Publication
(10) Pub. No.: US 2013/0011583 A1
(43) Pub. Date: Jan. 10, 2013

(54) STRUCTURAL ELEMENT

(76) Inventor: Dieter Knauer, Wendlingen (DE)

(21) Appl. No.: 13/520,441

(22) PCT Filed: Dec. 10, 2010
(86) PCT No.: PCT/DE10/01446

§ 371 Date: Jul. 3, 2012

(30) Foreign Application Priority Data
Jan. 13, 2010 (DE) 10 2010 005 066.0

(51) Int. Cl. B32B 3/28

(52) U.S. Cl. 428/12

(57) ABSTRACT

A structural element includes sectors (12 to 15) of a material layer (11) that are foldably connected along hinge axes (16 to 18) and are foldable open and closed in a fan-like manner about a pivot center (19). A second material layer (21) is disposed on a subregion of a broad side (20) of the material layer (11), which has sectors (25 to 28) that are foldably connected to each other along hinge axes (22 to 24) and can be folded open and closed. The hinge axes (16 to 18) of the material layers, in the folded-open state of the structural element (10), each extend radially in the manner of rays with respect to the pivot center (19) and delineate the sectors (12 to 15 and 25 to 28) from each other. The sectors (25 to 28) of the second material layer adjoin each other within flat, curved or arched surface.

The invention relates to a structural element, which comprises sectors of a material layer that are foldably connected to each other along hinge axes and that can be folded open and closed in a fan-like manner about a pivot center.

A structural element of this type is known (EP 1 090 204 B1). It is used as a closure device for windows, doors or similar openings of any type, including, inter alia, those of vehicles, where they are also used to cover vehicle windows. Such a closure device has proven effective to great advantage.

The problem addressed by the invention is that of creating a structural element of the initially mentioned type that can be used in diverse manners.

In a structural element of the initially mentioned type, the problem is solved according to the invention by the features of claim 1. A particularly advantageous embodiment results when the second material layer can be folded open to form an approximately flat surface shape. In the folded-open or fanned-out state, such a structural element is a substantially bend-proof and buckle-proof surface element, which, due to the folded-open first material layer, has a wall region on one side that has an approximately accordion-like or zigzagged shape and, on the other side, for example the visible side, makes possible a substantially planar surface element having an approximately flat surface shape due to the second material layer. Said approximately flat surface is easy to clean and can also be outfitted with any type of text-based or image-based information, which is printed directly thereon, is bonded thereto as printed film, or is applied in any other manner. Said surface can also have a colorful design. It is also suited for use as an advertising surface and an advertising medium, for example for corporate advertising, for advertising associations of any type or the like, or to depict any type of personal motives such as, for example, family, pets, personal sporting activities, mood images, etc. Said flat surface can also be configured as a design element, which imparts a highly particular, personal touch to a vehicle, for example, as the carrier. Furthermore, said second material layer can be used in general as a carrier element for any possible functional means, for example to install solar cells, lighting elements, information elements, reflection elements, LED elements or OLED elements, etc. Instead thereof or in addition thereto, the second material layer itself can also be designed as a functional element, for example as reflective film, solar film, projection film, electroluminescence film or the like. The structural element, which is made of at least the first material layer and the second material layer has great strength in the folded-open state and can therefore also be used as a wall element, for example a partition element, a shower curtain, as screening means, for example for the patio and balcony, and as a closure device for any type of opening, as a curtain, for shading, for example as an awning, sun shield, as a roof element or in any other diverse manner. Depending on the application, the fact that the intermediate space between the material layers, comprising the air volume located thereon, can provide sound and temperature insulation is also advantageous. Given that the material layers can be folded closed in an accordion-like manner when unused, a state is attained in this folded-closed state of the structural element that requires little space and can be easily stored in available spaces since the dimensions are now small. Since, in said folded-closed state, the second material layer is folded close approximately in the manner of an accordian, it is particularly well protected, more particularly the visible surface thereof, when the second material layer, including the sectors thereof, is advantageously accommodated between the sectors of the first material layer when folded closed. Due to the special, good properties, the structural element can also be used advantageously, inter alia, as a cover element for window openings, door openings and, for example, openings of a vehicle window. Furthermore, the structural element can also be used as a flat, transparent pane element instead of a window pane, door pane or the like, for installation in buildings, vehicles, etc. In every case the structural element is simple and cost-effective.

At least one adapted guide element, for example a U-shaped profile or the like, can be assigned to the outer edge of the material layers, in which the material layers run when fanned open and are then guided and supported at the edge. Due to the high loadability of the structural element transversely to the clamping plane, it can form highly diverse types of protection and blocking elements, for example fence elements, door elements, gate elements, passage barriers, fire protection walls, break-in protection elements, swimming pool covering elements, makeshift webs that can be walked on, protective surfaces against the effects of weapons. Moreover, the structural element can also be used to create spaces, makeshift accommodations or the like. They can also be used to create container walls or even entire containers for fluids and bulk goods, for example. The structural element can also be used as a barrier wall, for flood protection, for example, wherein in this case several elements lined up next to each other create a protective wall. In another embodiment, the structural element can be designed as a wind-loadable element, for example as a sail. Furthermore, the structural element can be designed as a projection surface of different sizes.

Further advantageous features of the invention and embodiments will become apparent from the dependent claims.

Further details and advantages of the invention will become apparent from the description that follows.

The complete wording of the claims is not presented above, merely to avoid unnecessary repetitions. Instead, reference is made thereto by referring to the claims, and all of these claim features are considered to have been disclosed here expressly and in a manner that is essential for the invention. All of the features mentioned in the description above and below, and the features that may be deduced exclusively from the drawing are also further components of the invention, even if they are not given special emphasis and, more particularly, if they are not mentioned in the claims.

The invention is explained in greater detail in the following with reference to exemplary embodiments shown in the drawings. Shown are:

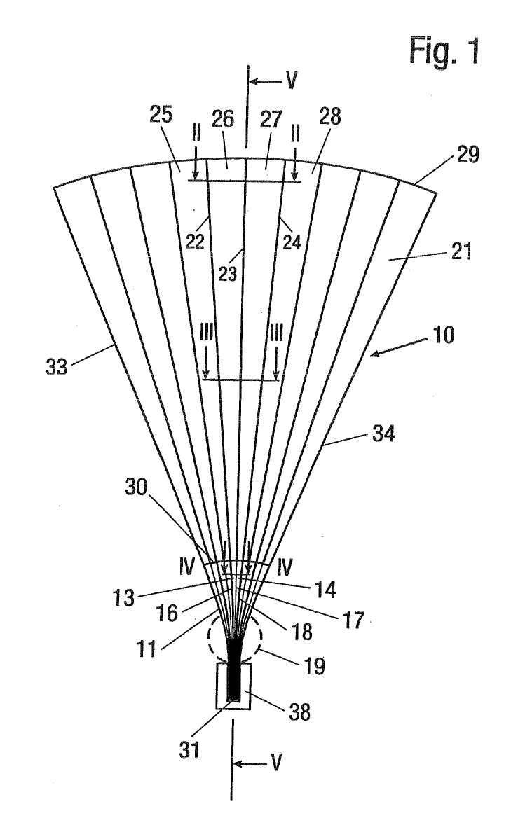

FIG. 1 a schematic front view of a structural element in the folded-open state,

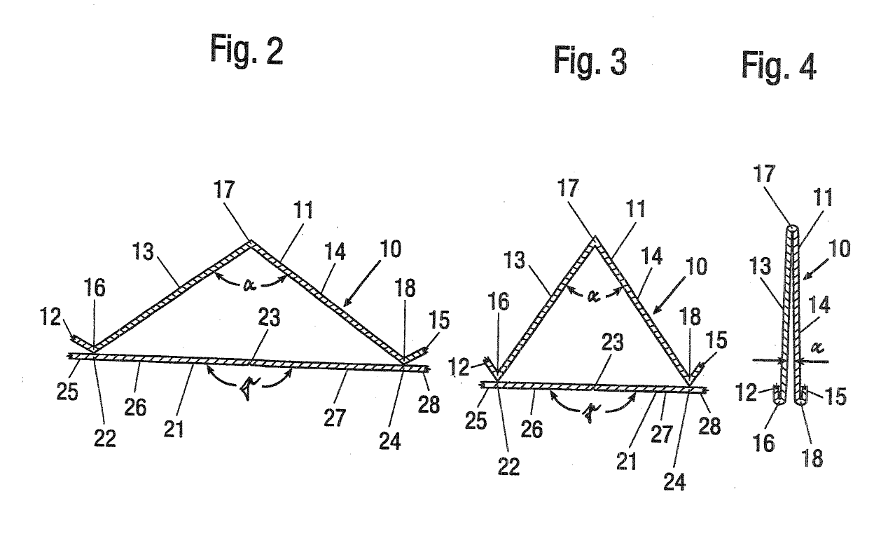

FIG. 2 a schematic sectional view along the line II-II in FIG. 1,

FIG. 3 a schematic sectional view along the line III-III in FIG. 1,

FIG. 4 a schematic sectional view along the line IV-IV in FIG. 1,

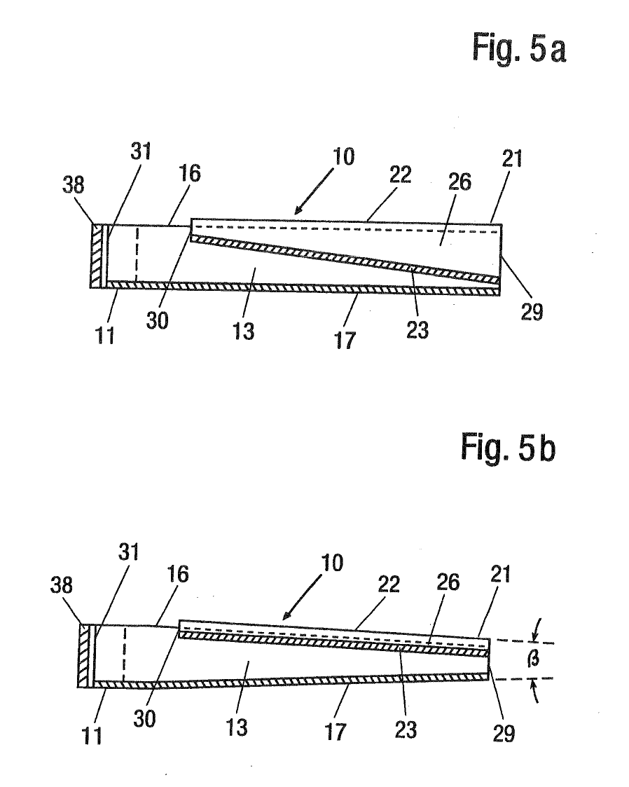

FIGS. 5a and 5b a schematic sectional view along the line V-V in FIG. 1 in the folded-together state and in the folded-open state of the structural element, respectively,

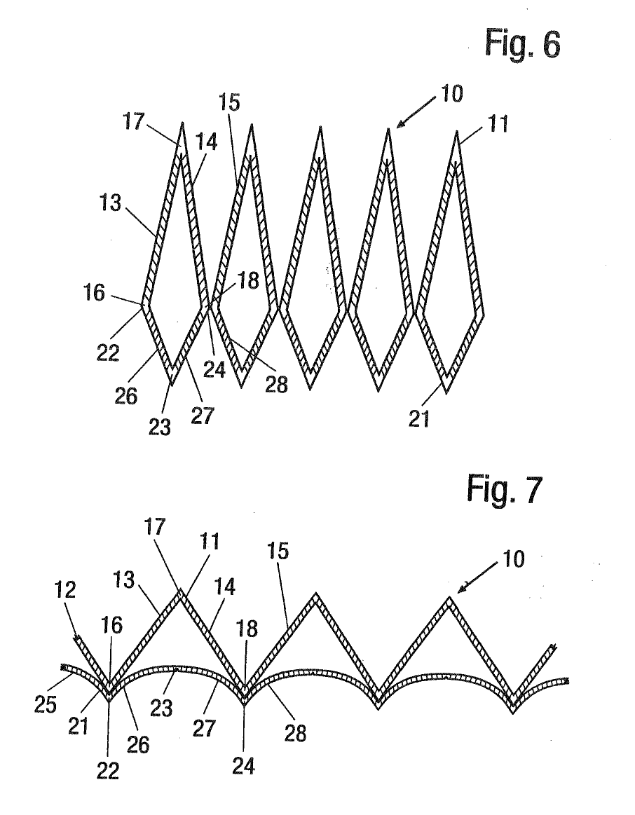

FIG. 6 a schematic sectional view that approximately corresponds to the sectional view in FIG. 2, wherein the structural element has already been largely folded closed, however, according to a second exemplary embodiment,

FIG. 7 a schematic sectional view of the structural element that approximately corresponds to the sectional view in FIG. 2, according to a third exemplary embodiment,

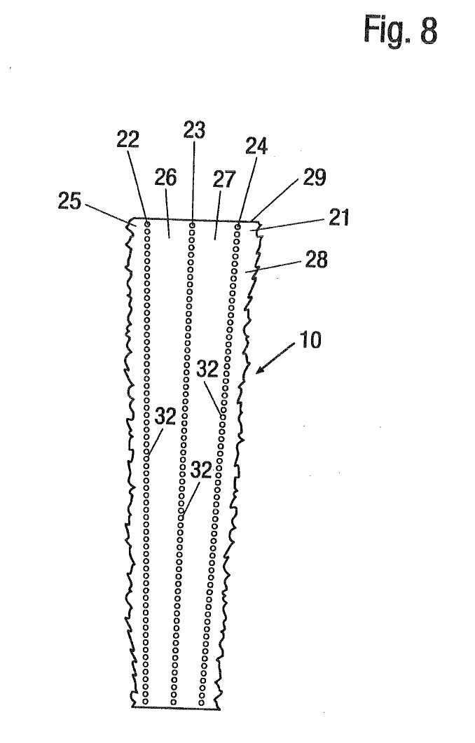

FIG. 8 a schematic view of a part of a structural element according to a fourth exemplary embodiment,

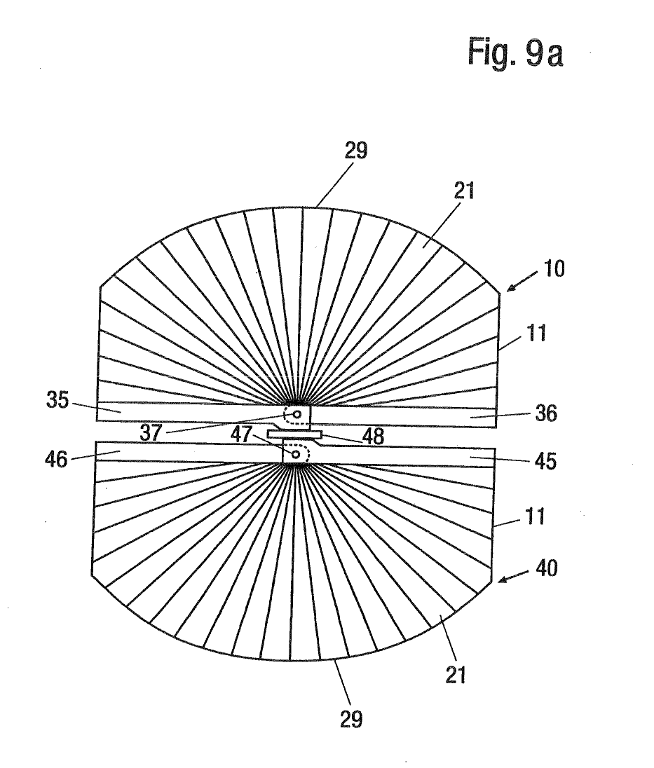

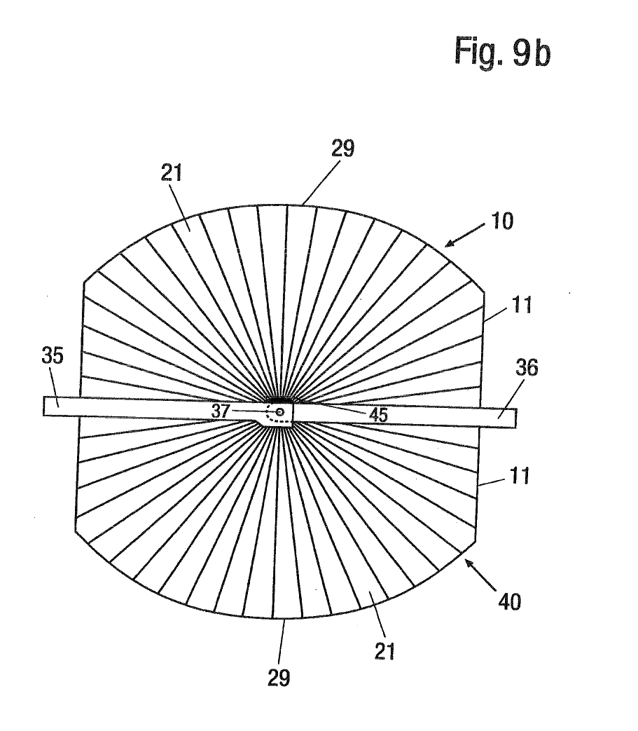

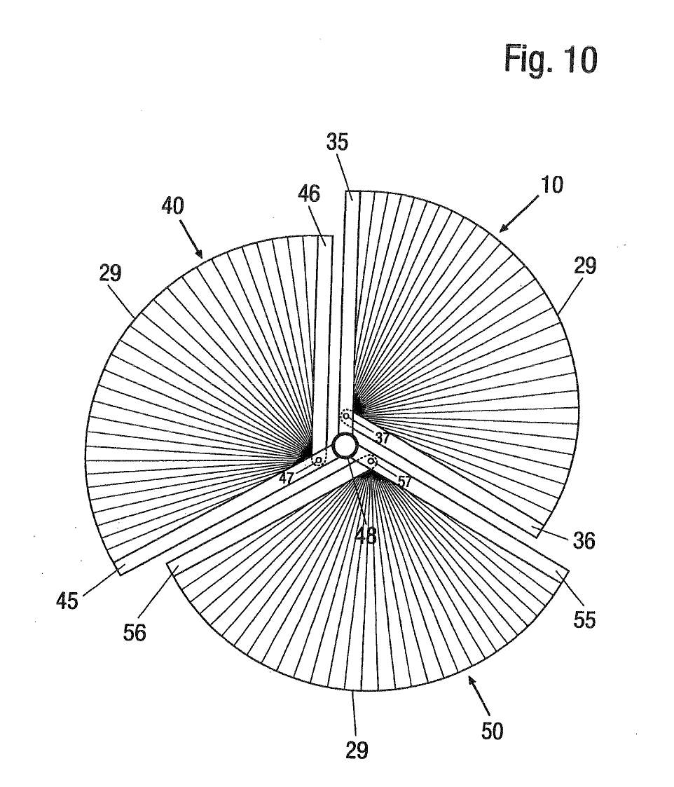

FIGS. 9 a and 9b a schematic view of arrangements comprising two structural elements, which are folded open,

FIG. 10 an arrangement comprising three structural elements, which are folded open,

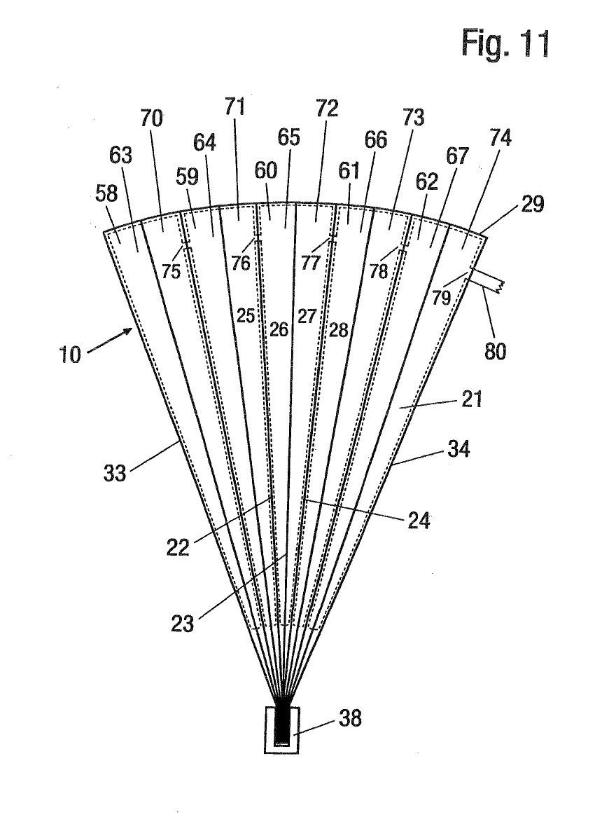

FIG. 11 a schematic front view, which approximately corresponds to FIG. 1, of a structural element according to a further exemplary embodiment,

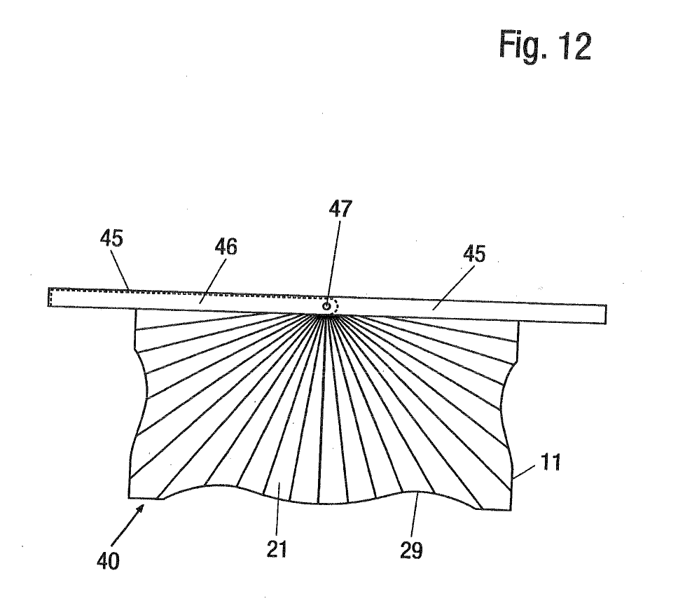

FIG. 12 a schematic view, which approximately corresponds to FIG. 9b, of an arrangement of a structural element.

The drawings show a structural element 10, a subregion or a complete element of which is shown in FIG. 1, for example. The structural element 10 comprises a first material layer 11 formed of mutually adjoining sectors 12 to 15 and others, which are foldably connected to each other along hinge axes 16, 17, 18 and others, and which can be folded open and closed approximately in a fan-like manner. The material layer 11 and others described in the following can be made of flexible material, for example, more particularly of a film. The hinge axes 16, 17, 18 and others can be formed, preferably, of impressed creases of pleat folds, for example. The individual sectors 12 to 15 and others are delineated from each other by the hinge axes 16, 17, 18 and others. The material layer 11 is pleated, thereby forming the sectors 12 to 15 as foldably connected, individually rotatable strip parts, and has a structure that is approximately zigzagged. The structural element 10 has a pivot center, which is indicated schematically by numeral 19, about which the structural element 10 can be folded open in a fan-like manner into the position according to FIG. 1 and can be folded closed in the opposite direction into the position approximately according to FIG. 4, wherein the individual sectors 12 to 15 are folded into a stack in the region of the hinge axes 16 to 18. The folded sectors 12 to 15 are joined and held together at the end region close to the pivot center 19 using a clamp 38, for example.

At least one second material layer 21 is disposed on at least one subregion of a broad side 20 of the first material layer 11, for example on the broad side 20 facing the observer in FIG. 1, said second material layer comprising sectors 25 to 28, and others, that are foldably connected to each other along hinge axes 22, 23, 24 and can be folded open and closed, at least a few of which are connected to the first material layer 11 in the region of hinge axes that face one another and are directly adjacent to one another. Accordingly, the second material layer 21 is connected in the region of the hinge axes 22 and 24 thereof to the first material layer 11 in the region of the hinge axes 16 and 18. The hinge axis 17 of the first material layer 11 and the hinge axis 23 of the second material layer 21 are not connected to one another. When the first and/or second material layer 11, 21 is folded, the sectors 25 to 28 can be folded closed and folded open in the opposite direction in the region of the hinge axes 22 to 24 thereof. The sectors 26 and 27 of the second material layer 21 and the sectors 13 and 14 of the first material layer 11 are folded, in the region of all hinge axes, in the sense of being folded closed, and therefore, in the folded-closed state that is not shown, for example, the second material layer 21, including the sectors 25 to 28 thereof, is accommodated in the region between the sectors 12 to 15 of the first material layer 11. When the material layers 11, 21 are folded open in the opposite direction, which is initiated by folding-open the first material layer 11, for example, the sectors 25 to 28 of the second material layer 21 are folded open until an approximately flat surface shape is formed, as depicted in FIGS. 1 to 3. FIG. 5a shows a sectional view in a folded state in which the structural element 10 is folded closed as compared to FIG. 1. As shown, the sectors 25 to 28 of the second material layer 21, at least in the folded-closed state, extend at least by way of one hinge axis 22 or 24 of the hinge axes 22 to 24 thereof along one of the hinge axes 16, 18 of the first material layer 11 and approximately parallel thereto and, further, by way of another hinge axis 23 of the hinge axes 22 to 24 thereof, at a slant with respect to at least one hinge axis 17 of the hinge axes 16 to 18 of the first material layer 11. It is also shown that the sectors 25 to 28 of the second material layer 21 have a shape with respect to the width thereof that is approximately triangular or approximately trapezoidal, for example wedge-shaped. The width of the sectors 25 to 28 of the second material layer 21 decreases in the direction toward the pivot center 19. Instead thereof, in other embodiments of the structural element 10, at least one part of said sectors 25 to 28 can also be approximately rectangular. The sectors 12 to 15 of the first material layer 11 are each approximately rectangular, although they can each be approximately triangular or trapezoidal.

The arrangement in terms of the two material layers 11 and 21 is selected such that, in the folded-open state of the structural element 10, the hinge axes 16 to 18 and 22 to 24, respectively, thereof each extend radially in the manner of rays with respect to the pivot center 19, as shown in FIG. 1. Starting from the outer edge 29, the sectors 25 to 28 can extend along the entire length of the sectors 12 to 15 of the first material layer 11 or they can terminate at any distance before the ends 31 of the sectors 12 to 15.

In the first material layer 11, the sectors 12 to 15 and others are delineated by the hinge axes 16 to 18 and others. In the second material layer 21, the sectors 25 to 28 thereof, and others, are delineated from one another by the hinge axes 22 to 24 thereof, and others. Advantageously, the sectors 12 to 15 and 25 to 28 are connected to each other as one piece and are preferably folded in the region of the hinge axes, and therefore, when folded closed, each material layer 11, 21 automatically folds in the region of the assigned hinge axes.

In the folded-open state of the structural element 10, the sectors 25 to 28 and others of the second material layer 21 adjoin each other, for example approximately within a flat or curved or arched surface, or extend toward one another at an angle. An at least approximately flat surface shape is advantageous. As a result, the second material layer 21 can be used in diverse manners due to said flat surface shape on the side facing away from the first material layer 11. For example, at least the second material layer 21 is designed as at least one functional element, for example as an information carrier, a reflection element, a lighting element, a solar element, a projection element or the like. In the embodiment as an information carrier, any type of text-based or image-based information can be applied on the side of the second material layer 21 facing away from the first material layer 11, for example by printing thereon or by attaching a printed film. The second material layer 21 can have a colorful design at least on said broad side, at least in regions. Due to the approximately flat surface shape of the second material layer 21, for example, which can be produced in the folded-open state of the structural element 10, said second material can also be easily cleaned and is easily accessible in general on the side facing away from the first material layer 11. The second material layer 21 can also be designed as a carrier element for at least one functional means, for example for solar cells, lighting elements, information elements, reflection elements or the like.

The structural element 10 has great strength in the folded-open state that is shown, which is achieved by the approximately V-shaped orientation of the sectors 12 to 15 of the first material layer 11 with respect to one another and by the zigzagged course, and by the fact that the second material layer 21 contributes to the loadability of said structural unit in the region of the hinge axes 16, 18 due to the connection there. As shown, the maximum angle α formed by two adjacent sectors 13, 14 of the first material layer 11 in the fully folded-open state of the structural element 10 in the region of the outer edge 29 is predefined and limited, when the first material layer 11 is folded open, by the folding open of the second material layer 21 up to the at least approximately flat surface shape thereof, as shown in FIGS. 1 to 3. In this manner the sector pair 26, 27 of the second material layer 21 functions as a limiting element for an assigned sector pair 13, 14 of the first material layer 11.

In a first exemplary embodiment according to FIGS. 1 to 5b, it is achieved, for example by way of appropriate impressing of the hinge axes 22 to 24 of the second material layer 21, that the second material layer 21, including the sectors 25 to 28 thereof, is accommodated between the sectors 12 to 15 of the first material layer 11 when the first and/or second material layer 11, 21 is folded closed. In the folded-closed state of the structural element 10, a stack thickness thereof is therefore achieved that is determined approximately by the thickness of the individual sectors 12 to 15 and others, and by the sectors 25 to 28 and others, having a width according to the sectors 12 to 15.

Instead thereof, the arrangement can also correspond to the second embodiment according to FIG. 6 and can be designed such that, when the first and/or second material layer 11, 21 is folded closed, the second material layer 21, including the sectors 25 to 28 thereof, and others, extend outside of the sectors 12 to 15 and subsequent ones of the first material layer 11. Such an embodiment can be advantageous depending on the spatial requirements, material selection of the material layers or the like. Depending on the material thickness of the first material layer 11 and the second material layer 21, a narrower, lower fold package of the structural element 10 can therefore result in the folded-closed state.

As shown in FIG. 1 and FIG. 5a, the sectors 25 to 28 and others of the second material layer 21 extend by way of at least one hinge axis 22 or 24 along one of the hinge axes 16, 18 of the first material layer 11 and approximately parallel thereto, wherein said hinge axes extend substantially within a common plane and that, in contrast, the hinge axes 23 that are not connected to the first material layer 11 extend at a slant with respect to the hinge axes 17 of the first material layer 11, which are located at a distance therefrom.

FIG. 5b clearly shows that, in the folded-open state, the distance of the hinge axes 16 and 18, which are located opposite each other, from 17 of the first material layer 11, as measured approximately at a right angle to the clamping plane of the structural element 10, decreases starting from the pivot center 19 and extending to the opposite, outer edge 29. This is indicated by the angle β. As shown in FIG. 5b, the hinge axes 16 and 17 form an acute angle β.

In FIG. 1, the sectors 12 to 15 and others of the material layer 11 are combined to form a layer block in the region of the inner end 31 thereof and are held by a clamp 38. At least in this region, the sectors 12 to 15 and others are oriented approximately at a right angle to the clamping plane of the structural element 10. FIG. 4 shows how two sectors 13, 14 of the material layer 11 are oriented close to the inner end 31 and close to the pivot center 19, and that they extend approximately at a right angle to the clamping plane of the structural element 10. The angle α between two sectors 13 and 14, which is sketched in FIGS. 2 to 4, increases when the sectors 13 and 14 are folded open, wherein said angle α increases starting from the inner end 31 and extending to the outer edge 29. In the region of the outer edge 29, the angle α between two sectors 13 and 14 can amount to a maximum of approximately 180°, wherein the outer edge 29 extends approximately in a straight line. As a result, as the fanning-open of the structural element 10 increases, the hinge axes 16 to 18 and others extend toward one another at a slant with respect to the longitudinal extension thereof, from the inner end 31 toward the outer edge 29, forming an acute angle β, having a distance that decreases from the inner end 31 toward the outer edge 29 (FIG. 5b).

In the third exemplary embodiment in FIG. 7, it is shown that the sectors 25 to 28 and others of the second material layer 21 are connected to the first material layer 11 at least partially in a planar manner, along the edge region extending on both sides of the hinge axes 16, 22 and 18, 24. In this manner an at least slightly arched course of the second material layer 21 results, at least in the connecting region, in the folded-open state of the structural element. Said planar connection can be created by bonding, welding or a similar adhesive connection.

In the fourth exemplary embodiment, which is shown in FIG. 8, it is shown that the hinge axes of at least one material layer 11, 21 each have perforation lines 32, as shown for the hinge axes 22 to 24 and others of the adjacent sectors 25 to 28 of the second material layer 21. Hinge axes 22 to 24 having such a design can be manufactured and pre-impressed more easily and simply, depending on the material of the material layer 21, while creating the related memory effect. It is advantageous if at least the hinge axes 22 and 24 of the second material layer 21 are formed of a plurality, for example two, perforation lines 32 that extend approximately parallel toward one another with very little separation. Said separation can approximately correspond to the hole diameter of the perforation points. Furthermore, it can be advantageous if the hinge axes 22 to 24, which are designed as perforation lines, extend toward one another at any angle on a film clamped in a planar manner, for example, and therefore the sectors 25 to 28 can have a wedge shape, for example in the form of a triangle or a trapezoid. Moreover, it can be advantageous that the preconditions are therefore created for connecting the sectors 25 to 28 of the second material layer 21 more easily and simply to the sectors 12 to 15 of the first material layer 11 along the facing hinge axes 16, 22 and 18, 24 thereof, in a punctiform manner, for example. Instead of such a punctiform connection or in addition thereto, a linear connection is also possible, as shown in the remaining drawings. In the folded-closed starting state of the structural element 10, it can have the approximate structure of a fan having a pivot center 19 at the end region that is opposite the outer edge 29. In said folded-closed state, the individual sectors 12 to 15 and others of the first material layer 11 are moved as close to each other as possible in the region of the hinge axes 16 to 18 and others, which applies similarly to the folded-closed sectors 25 to 28 of the second material layer 21 in the region of the hinge axes 22 to 24 and others, wherein in said folded-closed state, the sectors 25 to 28 and others can be accommodated between the sectors 12 to 15 and others of the first material layer 11. In said folded-closed state of the structural element 10, a compact, narrow element is obtained that requires only a small amount of space.

The structural element 10 is activated by it being folded open approximately in a fan-like manner about the pivot center 19 by folding open the first material layer 11 and/or the second material layer 21. As a result, the sectors 12 to 15 and others of the first material layer 11 are folded open in the region of the hinge axes 16 to 18 and others. At the same time, the sectors 25 to 28 and others of the second material layer 21 are folded open in the region of the hinge axes 22 to 24 and others and, in fact, to such an extent that the specified angle α formed by two adjacent sectors 13, 14 of the first material layer 11 is attained, wherein said angle α is predefined and limited by the folding-open of the second material layer 21 until the surface shape is at least approximately flat, as shown in FIGS. 2 and 3, in which the sectors 25 to 28 and others of the second material layer 21 adjoin one another in a flat-surface manner approximately within a plane. The second material layer 21 functions as a limiting element in this case. Said fully folded-open state of the structural element 10 can be secured, for example, by way of forces engaging at the end edges 33 and 34 and acting in the folding-open direction, for example by way of strips or similar fixing elements engaging thereon, said strips or similar fixing elements being held in the fanned-out state of the structural element 10 at holders, which are not shown.

In order to return the structural element 10 to the starting state and fold it closed, an approximately fan-type motion in the opposite direction about the pivot center 19 is required until the individual sectors 12 to 15 and others of the first material layer 11 and the sectors 25 to 28 and others of the second material layer 21 have reached the respective folded-closed state. This can also be secured, as necessary, by way of the retaining elements engaging at the end edges 33, 34, for example.

In the folded-open state of the structural element 10, the hinge axes 16 to 18 and others of the first material layer 11 have a curved shape, starting from the pivot center 19 and extending to the opposite edge 29, that increases toward the edge 29, as is easily recognized by a person skilled in the art. The hinge axes 22 and 24 of the second material layer 21, which are directly adjacent to the hinge axes 16 and 18 of the first material layer 11, extend approximately in a straight line along the entire length thereof, also in the folded-open state of the structural element 10. Due to this fact, an air gap that increases toward the outer edge 29 forms between directly adjacent hinge axes 16, 18 and 22, 24 of the material layer 11 and 21, respectively, in the folded-open state of the structural element 10, wherein said air gap is largest when the angle α formed by the sectors 13, 14 of the first material layer 11 in the region of the outer edge 29 is approximately 180°. In order to equalize the formation of said air gap between directly adjacent hinge axes 16, 18 and 22, 24 of the first material layer 11 and the second material layer 21, the second material layer 21 is connected, advantageously, in a flexible and/or displaceable manner to the first material layer 11, or is disposed at least along part of the entire length of the hinge axes 22, 24 without any connection to the first material layer 11. It can be advantageous if at least some of the directly adjacent hinge axes 16, 18 and 22, 24 of the first material layer 11 and the second material layer 21 are displaceably connected to each other over part of the total length thereof starting from the outer edge 29 and extending to the pivot center 19 and/or are disposed such that they are fully disconnected from each other.

In a further exemplary embodiment, which is not shown, a third material layer, for example a protective layer, can be provided on the broad side of the second material layer 21, which faces away from the first material layer 11. Said third material layer can be held on the first material layer 11 and/or second material layer 21 by way of holders. The third material layer can be connected to the second material layer 21. When the first material layer 11 is folded closed with the second material layer 21 and the third material layer, said third material layer can extend within or outside of the sectors 25 to 28 and others of the second material layer 21.

Furthermore, in another exemplary embodiment, which is not shown, a fourth material layer can be provided on the broad side of the first material layer 11, which faces away from the second material layer 21, said fourth material layer being preferably formed and disposed similarly to the second material layer 21, for example. The third and/or fourth material layer can then also be folded open and closed in the opposite direction about the pivot center 19 along with the first material layer 11 and the second material layer 21. Furthermore, the material layers 11, 21 and others can be contoured, for example cut to fit, according to specifications by way of the edge region 29 furthest from the pivot center 19, thereby resulting in edge shapes that are curved and/or straight and/or pointed or the like. By way of the fourth material layer, a structural element 10 is produced that can have an approximately flat surface shape, for example, on both broad sides.

In the exemplary embodiment according to FIG. 9a, an arrangement is shown in which a plurality of structural elements are combined in a complementary structural arrangement. According to FIG. 9a, two structural elements 10 and 40 are combined to form an arrangement in which each structural element 10, 40 can be fanned out to form a fan angle of approximately 180°. It is also clear that each individual structural element 10, 40 can also be used alone, detached from other structural elements, and can be fanned out to a fan angle of up to approximately 180°. The particular structural element can advantageously comprise edge webs 35, 36 and 45, 46, which engage, for example, at the outer edges 33, 34 at least of the first material layer 11 and are pivotably connected to each other in the region of a hinge axis 37 or 47, for example, such that a relative pivoting of the edge webs 35, 36 or 45, 46 makes it possible to fold open the structural element 10 or 40, respectively, into the particular end position shown in FIG. 9a, for example, and to fold it closed in the opposite direction. In the folded-upon state of the structural element 10 or 40, the edge webs 35, 36 or 45, 46, respectively, can be fixed with respect to one another, for example in the region of the pivot axis 37 or 47, respectively, thereby securing the folded-open state of the structural element 10 or 40, respectively.

It is understood that, instead thereof, in the case of the particular structural element 10 and 40, the material layers 11, 21 and others can be fanned open in a stepless manner up to a fan angle measured from an outer edge 33 to the other edge 34, which is greater than 90°, for example approximately 120°, 180° or up to 270°, and are preferably fixable in said position.

As shown in FIG. 9a, in the particular structural element 10 and/or 40, the fanned-out material layers 11, 21 and others can pivot as a whole in the fanned-out state within a spatial coordinate system. To this end, the particular structural element 10 and/or 40 can be held in the region of an outer edge 33, 34 at or in a carrier 48, for example a carrier profile. Said carrier 48, as a holder of a structural element 10 and/or 40 in the region of an outer sector or as a holder of two structural elements 10 and 40, can pivot about three axes in order to place the structural element 10 and/or 40 held thereby in a specific orientation within a spatial coordinate system.

In the exemplary embodiment according to FIG. 9a, it is also clearly shown that the material layers 11 and/or 21 and other material layers are contoured according to particular specifications at the edge region 29 thereof furthest from the pivot center, for example according to FIG. 9a, in such a way that each structural element 10 or 40, in the folded-open state, results in an at least approximately rectangular shape having, for example, only a slight arched curvature at the outer edge 29.

In FIG. 9a, both structural elements 10 and 40 are disposed approximately within a plane, wherein, as a result, at least in the fanned-out functional state of the two structural elements, an intermediate space forms between the edge web pair 35, 36 and the edge web pair 45, 46 that is not covered by either of the two structural elements 10, 40. FIG. 9b shows an arrangement comprising two structural elements 10, 40, wherein an intermediate space is not present between the two structural elements 10 and 40 as seen in a top view of said arrangement. This is achieved in that the structural element 10 extends in an upper plane and the structural element 40 extends in a lower plane located therebelow. The edge web pair 45, 46, which has been folded open, is located underneath the edge web pair 35, 36 and substantially in alignment therewith, wherein the distance measured between the two edge web pairs 45, 46 and 35, 36 in this position can approach zero. The structural elements 10, 40 can extend in planes that extend in parallel or toward one another at an angle.

In the exemplary embodiment shown in FIG. 10, three structural elements 10, 40 and 50 are combined to form an arrangement, wherein each structural element can be fanned open to form a fan angle of approximately 120°, for example. In this case as well, the individual structural elements 10, 40 and 50 can pivot within a spatial coordinate system, either relative to one another and each element separately or in combination, for example as an approximately circular disk-shaped pivoting unit. The structural elements 10, 40 and 50 are equipped with edge webs 35, 36 and 45, 46 and 55, 56, respectively, as in FIG. 9a, which are connected in the region of a pivot axis 37 or 47 or 57, respectively, such that they can pivot relative to one another. The individual structural elements 10, 40 and 50 are either retained such that each one can pivot at a carrier 48 within a spatial coordinate system, or, instead, the carrier 48 is used to hold all three structural elements 10, 40 and 50 together, in the region of the respective edge webs 35, 45, 55, for example, to form one unit. In this case as well, said unit can preferably pivot within a spatial coordinate system and, therefore, about three axes, in order to orient said arrangement to the particular spatial circumstances.

The exemplary embodiments depicted in FIGS. 9a and 9b and in FIG. 10 in particular are suitable for use to form solar elements, for example. In that case, the second material layer 21 is either designed as a carrier element for any type of solar cell or is designed as solar film itself. The particular solar element can be mounted on vehicles of any type, for example personal vehicles, trucks, busses, agricultural vehicles, campers, bicycles, motorcycles, motor scooters, ships or the like, either permanently or in a replaceable manner. They are mounted in the upper region, for example, in the roof region, for example or on the lateral region of the vehicles.

When the vehicle is in motion, the solar element is in the folded-together, space-saving storage state, and therefore the air resistance caused by the solar element is extremely low. In the parked state, in a traffic jam or during very slow travel of the vehicles, for example, river boats, agricultural vehicles, during partial delivery travel or the like, the solar element is moved in part or in entirety into the surface-forming functional position in which incident solar radiation is converted into electrical energy.

The fact that the surface area of the solar elements available for energy collection can be larger than the basic surface of a vehicle is of particular advantage since the solar elements can extend beyond the outer boundary edge of an assigned vehicle. It is furthermore advantageous that the range of an electric vehicle can be extended considerably relative to the charging of a rechargeable battery.

In a second variant embodiment, the particular solar element can be installed on buildings of any type, for example on apartment buildings, production facilities, public buildings, garages or the like. They can be installed on walls or on roof surfaces. In that case, the solar element is delivered as a fully functional installation unit in the space-saving storage state and is installed at the site and the location. The aforementioned solar element can also be fastened to the ground if necessary.

Such solar elements can also be used for decentralized power generation in regions in which power line networks are present not at all or only under certain conditions, for example in developing countries. Such solar elements can also be used as emergency power elements in case of catastrophe.

Such a solar element comprises one or even a plurality of structural elements, which are held at a carrier 48 in the vicinity of the particular pivot center 19 thereof. The carrier 48 can be in the form of a mast, for example, which is fastened on a building or a vehicle, for example. The structural elements fastened on the carrier 48, for example a mast, can be rigidly connected to the carrier 48 or pivotable relative thereto.

A solar element formed of one or a plurality of structural elements can track the position of the sun, either in entirety by way of theR entire surfare thereof, or only in part by way of a subregion, in such a way that the angle of incidence of the solar rays is always 90°. This is a considerable advantage over solar cells that are installed on building surfaces and/or on vehicle surfaces in an unmovable manner.

In addition thereto, a further advantage of the solar element becomes apparent in snowfall or in sandstorms. While, after a snowfall or a sandstorm, known solar cells are covered by a material layer that is impermeable to solar radiation, the solar element is in the space-saving, folded-together non-functional position during snowfall or a sandstorm and can be restored to the flat functional position thereof immediately after the snowfall or the sandstorm subsides, thereby making it possible to immediately resume production of electrical energy.

The exemplary embodiment shown in FIG. 10 can be designed such that the edge webs 35, 45, 55 form approximately the same angle, which is less than 90°, for example 60°, with a carrier 48 that is designed as a mast, for example. In this manner an approximately funnel-shaped formation is created, in which the funnel opening can point upward or downward. If the regions present between the structural elements 10, 40, 50 are closed, such a funnel-shaped formation having an upwardly pointing funnel opening can be used as a container, for example, for collecting rainwater, for example.

In another embodiment, such a funnel-shaped formation having a downwardly pointing funnel opening can be used as tent-like, temporary protective space. In that case, the outer edges 29 of the structural elements 10, 40, 50 can be contoured such that there are no intermediate spaces present between the lower edge of the funnel-shaped formation, which lies on the ground, for example, and the ground itself. The outer surfaces of said funnel-shaped protective space can be equipped with solar cells, while the inner surfaces are formed, at least in part, as a lighting medium, which is supplied with the energy generated by the solar cells.

The structural elements 10, 40, 50 can also be designed as lights. In this case, the material layers 11 and/or 21 are designed as light-emitting foils, for example.

The arrangement of a plurality of structural elements 10, 40, 50 shown in FIGS. 9a and 9b and in FIG. 10 can also be used as a protective screen or a protective shield against rain, hail, snow, sand, sun, sound, the effects of weapons, radiation, chemical substances or the like.

The particular material layer 11, 21 can be made of plastic, metal, paper, cardboard or cloth, for example, or it can be made of a composite of two or more of the aforementioned materials. The wall thickness of the materials used can extend from a range of 1/1000 mm to the centimeter range. An individual sector of a particular material layer 11, 21, considered per se, can be designed as a flexible unit or as a rigid unit. The individual sectors of the material layers 11 and 21 can be designed either as a reflectance element, an absorption element, a transmission element or a combination element thereof, wherein any combination of these various elements is possible within a material layer and within an assigned structural element.

In the further exemplary embodiment depicted in FIG. 11, it is shown that actuators 58 to 62 that can be activated to fold the material layers 11, 21 open and/or closed are disposed between two material layers 11, 21, for example the first material layer 11 and the second material layer 21. Said actuators 58 to 62 can be acted upon by a pressure medium, for example, such a compressed air. Individual elements 63 to 67, which contain the pressure chambers 70 to 74, are provided as actuators 58 to 62. Said elements 63 to 67, more particularly the pressure chambers thereof, are connected to one another, for example by way of connecting lines 75 to 79, which are indicated, wherein they are supplied jointly by way of one connecting line 80, from a compressed air source, for example. It can be used to supply the pressure chambers 70 to 74 with pressure medium to fold open the structural element 10. If the structural element is in the folded-together storage state, which is not shown, pressure medium, for example compressed air, compressed gas or the like, can be introduced by way of the supply line 80 into the individual pressure chambers 70 to 74. The individual actuators 58 or 62 are thereby activated and increase in volume. They are inflated, for example, thereby unfolding the folded-together material layers 11 and 21. In this manner the structural element 10 is transferred into the functional position in which the material layer 21 has an approximately flat surface shape, for example. The actuators 58 to 62 can have various shapes. They can be inflatable pressure pads, pressure tubing, piston/cylinder assemblies or similar elements 63 to 67. It can be of particular advantage when the interior space formed between the two material layers 11, 21 itself is used as a pressure chamber 70 to 74, wherein said interior space is then closed to the outside in a pressure-maintaining manner. To fold the structural element 10 closed, the pressure chambers 70 to 74 are depressurized, for example being deventilated.

Instead of compressed gas, the pressure chambers can also be filled with a non-combustible medium, for example powder, foam, etc., which is pressed into the pressure chambers 70 to 74 under pressure. A fire protection wall is created in seconds in this manner.

If the individual pressure chambers 70 to 74 are filled with small spheres made of an appropriate material, a sound-proofing element or an insulating element is obtained. The individual pressure chambers 70 to 74 can also be filled with liquid pressure medium.

In the further exemplary embodiment shown in FIG. 12, a structural element 10 is held at a continuous edge web 45. An edge web 46 that is shorter than the edge web 45 is accommodated therein and can be connected to an edge of the structural element 10 and is held such that it can pivot about the pivot axis 47, while the other edge of the structural element 10, which is located on the right side of the pivot axis 47 in FIG. 12, is connected to the continuous edge web 45. FIG. 12 furthermore shows, with respect to the structural element, that the material layers thereof are contoured by way of the edge region 29 thereof, thereby resulting in edge shapes that are curved and/or straight and/or pointed or the like.

In FIG. 5b the hinge axes 16 to 18 of the first material layer 11 are depicted as straight axes extending toward one another, forming the angle β. In a modified exemplary embodiment, said hinge axes can extend, in the folded-open state of the structural element 10, in a curved shape at least over a portion of the entire length thereof. The curved shape can increase as it extends from the pivot center 19 to the opposite edge 29.

Even though one pivot center 19 for the particular structural element is shown in the individual figures, a particular structural element can also comprise at least two pivot centers in a modified exemplary embodiment.

Furthermore, it can be advantageous when at least some of the sectors 12 to 15 of the first material layer 11 are designed as mechanical energy accumulators. Said sectors are charged with energy by way of elastic deformation when the structural element 10 is folded open, said energy being usable at least in part for folding together. The actuators 58 to 62, which are acted upon by pressure medium, can be discharged at least partially by way of the sectors 12 to 15 of the first material layer 11, which are designed as charged energy accumulators in the fully folded-open state of the structural element 10. In the folded-open state of the structural element 10, the angle α formed by the sectors 13, 14 of the first material layer 11 can be adjusted by way of the edge webs 35, 36 at least of the first material layer 11 or by way of the actuators 58 to 62, which function as adjusting elements.

If the structural element 10 is moved out of the non-functional state thereof, in which the sectors 12 to 15 of the first material layer 11 and the sectors 25 to 28 of the second material layer 21 are in the folded-together stacked state, into the flat functional state thereof, the sectors 12 to 15 of the first material layer 11 are folded open away from each other and are simultaneously rotated individually at least over a portion of the longitudinal extension thereof. In this procedure of individual rotation, each sector 12 to 15 stores at least a portion of the energy that was introduced for folding open. Said energy remains stored until the structural element 10 is moved from the flat functional state thereof into the space-saving non-functional state thereof. In so doing, at least a portion of the energy required to fold open the structural element 10 is covered by the energy stored in the sectors 12 to 15 of the material layer 11. If above-described actuators 58 to 62, which can be acted upon with pressure medium, for example compressed gas or pressure fluid, in order to fold open the material layers 11 and 21, are disposed between two material layers 11, 21, for example the first material layer 11 and the second material layer 21, the energy stored in the flat folded-open state of the material layers 11, 21 in the sectors 12 to 15 of the material layer 11 can be used at least for partially discharging, for example, pressing the pressure medium out of the actuators 58 to 62, which are designed as pressure chambers 70 to 74. If the sectors 12 to 15 of the first material layer 11 and/or the sectors 25 to 28 of the second material layer 21 are already preloaded in the space-saving stacked state against being folded open, the pressure chambers 70 to 74, which are filled completely in the fully folded-open state of the structural element 10 and, therefore, the of the material layers 11, 21, can be fully discharged only of the energy stored within the sectors 12 to 15 of the first material layer 11 and/or the sectors 25 to 28 of the second material layer 21.

1-48. (canceled)

49. A structural element, comprising:
sectors (12 to 15) of a material layer (11) that are foldably connected to each other along hinge axes (16 to 18) and that are foldable open and closed in a fan-like manner about a pivot center (19), wherein at least one second material layer (21) is disposed on at least one subregion of a broad side (20) of the material layer (11), which comprises sectors (25 to 28) that are foldably connected to each other along said hinge axes (22 to 24) and are foldable open and closed, at least a few of which are connected to the first material layer (11) in the region of hinge axes (16, 18, 22, 24) that face one another and that foldably closed and opened in the opposite direction in the region of the hinge axes (22 to 24) thereof when the first and/or second material layer (11, 21) is folded, and wherein the hinge axes (16 to 18) of the first material layer (11) and the hinge axes (22 to 24) of the second material layer (21), in a folded-open state of the structural element (10), each extend radially in the manner of rays with respect to the pivot center (19) and delineate the sectors (12 to 15 and 25 to 28) from each other,
wherein the sectors (25 to 28) of the second material layer (21), in the folded-open state, adjoin each other approximately within an approximately flat or curved or arched surface.

50. The structural element according to claim 49, wherein a maximum angle formed by two adjacent sectors (13, 14) of the first material layer (11) in a fully folded-open state of the structural element (10) in the region of the outer edge (29) is predefined and limited, when the first material layer (11) is folded open, by the folding open of the second material layer (21) up to an at least approximately flat surface shape.

51. The structural element according to claim 49, wherein an angle (γ) formed by the sectors (26, 27) of the second material layer (21) in the fully folded-open state of the structural element (10) remains constant starting from the pivot center (19) and extending to the outer edge (29).

52. The structural element according to claim 49, wherein an angle (γ) formed by the sectors (26, 27) of the second material layer (21) in the fully folded-open state of the structural element (10) increases or decreases starting from the pivot center (19) and extending to the outer edge (29).

53. The structural element according to claim 49, wherein, when the first and/or the second material layer (11, 21) is folded closed, the second material layer (21), including the sectors (25 to 28) thereof, is accommodated between the sectors (12 to 15) of the first material layer (11).

54. The structural element according to claim 49, wherein the sectors (25 to 28) of the second material layer (21) are approximately triangular or are approximately trapezoidal, for example wedge-shaped, or that at least one part of the sectors (25 to 28) of the second material layer (21) is approximately rectangular.

55. The structural element according to claim 49, wherein the sectors (25 to 28) of the second material layer (21) extend, at least in the folded-closed state, by way of one hinge axis (23) of the hinge axes (22, 23, 24) thereof, at a slant with respect to at least one hinge axis (17) of the hinge axes (16 to 18) of the first material layer (11), preferably that the width of the sectors (25 to 28) of the second material layer (21) decreases in the direction toward the pivot center (19).

56. The structural element according to claim 49, wherein the sectors (12 to 15) of the first material layer (11) are each approximately rectangular or are each approximately triangular or trapezoidal.

57. The structural element according to claim 49, wherein, in the folded-open state of the structural element (10), the distance between the hinge axes (16, 18 and 17) of the first material layer (11) that are located opposite each other, as measured approximately at a right angle to the clamping plane of the structural element (10), decreases starting from the pivot center (19) to the opposite, outer edge (29) (angle β).

58. The structural element according to claim 49, wherein the hinge axes (16 to 18) of the first material layer (11), in the folded-open state of the structural element (10), have a curved shape at least over a part of the entire length thereof, more particularly having a curved shape that increases toward the edge (29) starting from the pivot center (19) and extending to the opposite edge (29).

59. The structural element according to claim 49, wherein at least some of the directly adjacent hinge axes (16, 18 and 22, 24) of the first material layer (11) and the second material layer (21) are displaceably connected to each other at least over a portion of the total length thereof starting from the outer edge (29) and extending to the pivot center (19) and/or are disposed such that they are fully disconnected from each other.

60. The structural element according to claim 49, wherein a third material layer, for example a protective layer, is provided on the broad side of the second material layer (21) that faces away from the first material layer (11), and preferably that a fourth material layer, which is preferably designed and disposed similarly to the second material layer (21), is provided on the broad side of the first material layer (11) that faces away from the second material layer (21).

61. The structural element according to claim 49, wherein the material layers (11, 21 and others) are contoured according to specifications by way of the edge region (29) furthest from the pivot center (19), thereby resulting in edge shapes that are curved and/or straight and/or pointed or the like.

62. The structural element according to claim 49, wherein at least the second material layer (21) is designed as at least one functional element, for example as an information carrier, a reflection element, a lighting element, a solar element, a projection element or the like, or is designed as a carrier element for at least one functional element, for example for solar cells, lighting elements, information elements, reflection elements or the like.

63. The structural element according to claim 49, wherein actuators (58 to 62) that can be activated, more particularly acted upon by pressure medium, to fold the material layers (11, 21) open and/or closed are disposed between two material layers (11, 21), for example the first material layer (11) and the second material layer (21).

64. The structural element according to claim 49, wherein at least some of the sectors (12 to 15) of the first material layer (11) are designed as mechanical energy accumulators, which are loaded with energy via elastic deformation when the structural element (10) is folded open, said energy being usable, at least in part, for folding together.

65. The structural element according to claim 49, wherein the sectors (25 to 28) of the second material layer (21) are connected to the first material layer (11), at least partially in a planar manner, along the edge region extending on both sides of the hinge axes (22, 24).
